(19) United States
(12) Patent Application Publication
(10) Pub. No.: US 2014/0191510 A1
(43) Pub. Date: Jul. 10, 2014

(54) PNEUMATIC THRUST COMBINED CYCLE POWER GENERATOR

(71) Applicant: Jung-Tsung Chen, Taichung (TW)

(72) Inventor: Jung-Tsung Chen, Taichung (TW)

(21) Appl. No.: 13/735,016

(22) Filed: Jan. 6, 2013

(51) Int. Cl. H02K 57/00

(52) U.S. Cl. CPC H02K 57/003
USPC 290/54

(57) ABSTRACT

A pneumatic thrust combined cycle power generator comprises a startup air compressor operated together with a high-pressure gas regulator to fill a high-pressure gas into a pneumatic motor and start operating a transmission bearing, such that the transmission bearing can drive a high power generation motor to produce a power generation effect and provide a power supply. The transmission bearing of the pneumatic motor can be operated with a driven gear and a transmission belt to drive a high-pressure gas recycle air compressor to operate, so as to return the high-pressure gas to the startup air compressor through a high-pressure gas recycle channel and achieve a combined cycle effect of using the high-pressure gas.

### BACKGROUND OF THE INVENTION

1. Fields of the Invention

The present invention relates to a pneumatic thrust combined cycle power generator, and more particularly to a self-power generation system that consumes little power and uses an easily available atmospheric resource as a power generation medium to satisfy the requirements of environmental protection and green energy.

2. Description of the Related Art

Environmental and climatic changes and gradual shortage of natural energy have been common global issues. Governments of different countries and related manufacturers spare no effort on the development of natural green energy sources such as solar, hydro, or wind energy (hereinafter referred to “green energy”) in recent years and develop self-power generation systems that consume very little or no power. The objective is to effectively reduce the long-term dependence on petroleum, natural gas, and coal (hereinafter referred to as petrochemical resources) and minimize damages to the environment and assure the sustainable development of the earth and human beings.

However, the development of green energy recourses and its effect are still insignificant up to now. No immediate contribution to the maintenance of the environment or the reservation of petroleum resources has been accomplished yet, mainly because the supply of green energy is very uncertain and a self-power generation system generally has the disadvantages of a high price and a high power loss during the transmission of the electric power. As a result, the expected effect of the green energy sources on human beings and the environment can be enhanced.

### SUMMARY OF THE INVENTION

A first object of the invention is to use a general free-of-charge atmospheric resource and a corresponding air compressor to compress the gas into a high-pressure gas, and use the high-pressure gas to drive a pneumatic motor and a high power generation motor in order to achieve the expected power generation effect. In the meantime, kinetic energy produced by the operation of a pneumatic motor transmission bearing is used for driving a high-pressure gas recycle air compressor, so that the high-pressure gas can be used continuously and repeatedly. In addition to the free access of a power generation medium (which is the atmospheric resource), the present invention also provides a sufficient supply of power through a cycle power generation and achieves the expected results of practicality, convenience, and cost-effectiveness.

According to the invention, a pneumatic thrust combined cycle power generator comprises a startup air compressor operated together with a high-pressure gas regulator to fill a high-pressure gas into a pneumatic motor and start operating a transmission bearing, such that the transmission bearing can drive a high power generation motor to produce a power generation effect and provide a power supply. The transmission bearing of the pneumatic motor can be operated with a driven gear and a transmission belt to drive a high-pressure gas recycle air compressor to operate, so as to return the high-pressure gas to the startup air compressor through a high-pressure gas recycle channel and achieve a combined cycle effect of using the high-pressure gas.

### BRIEF DESCRIPTION OF THE DRAWINGS

The accomplishment of this and other objects of the invention will become apparent from the following description and its accompanying drawings of which:

FIG. 1 is a flow chart of a preferred embodiment of the present invention; and

FIG. 2 is a flow chart of another preferred embodiment of the present invention.

### DETAILED DESCRIPTION OF THE PREFERRED EMBODIMENT

The present invention will now be described in more detail hereinafter with reference to the accompanying drawings that show various embodiments of the invention.

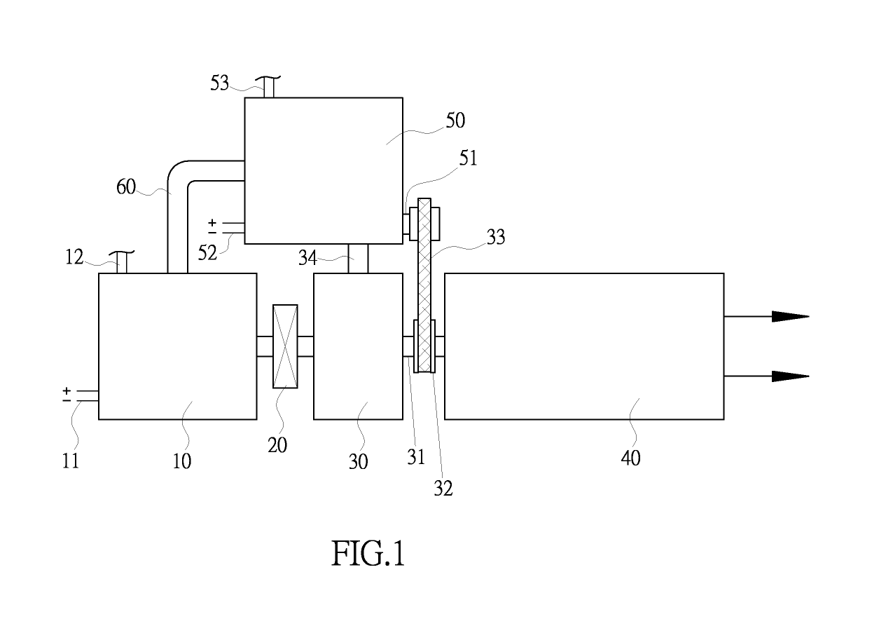

With reference to FIG. 1 for a flow chart of a preferred embodiment of the present invention, a startup air compressor 10 and a high-pressure gas regulator 20 are provided for filling a high-pressure gas into a pneumatic motor 30 to start the operation of a transmission bearing 31. The transmission bearing 31 is provided for driving a high power generation motor 40 to generate power as a source of power supply. In addition, the transmission bearing 31 of the pneumatic motor 30 can be operated together with a driven gear 32 and a transmission belt 33 to drive a high-pressure gas recycle air compressor 50 to operate. A high-pressure gas recycle channel 60 is provided for returning the high-pressure gas to the startup air compressor 10 to achieve a combined cycle effect of using the high-pressure gas.

Of course, it is necessary to turn on the startup air compressor 10 by an electric power of an external power supply 11 at an initial stage of the operation of the startup air compressor 10. The gas sucked into the external air inlet 12 is compressed into a high-pressure gas. In addition, a high-pressure gas recycle pipe 34 is installed between the pneumatic motor 30 and the high-pressure gas recycle air compressor 50.

Normally, a rotating shaft 51 of the high-pressure gas recycle air compressor 50 is driven by a transmission belt 33 to accomplish an expected operation performance. Of course, a spare external power supply 52 and a spare external air inlet 53 can be used for supplying the required power and high-pressure gas to maintain the overall normal operation of the power generation system when a special or emergency situation (such as a failure of the startup air compressor 10) occurs. The present invention further comprises a battery module (not shown in the figure) for storing additional generated power generated by the high power generation motor 40.

As we all know, regardless of a startup air compressor 10 or a high-pressure gas recycle air compressor 50, the air compressor generally comes with a pressure detector (not shown in the figure) The air compressor can be turned on automatically and operated when the level of detected pressure is too low. However, such arrangement is a prior art, and will not be described in details.

In the aforementioned assembly, the high-pressure gas regulator 20 is used for adjusting the flow of the high-pressure gas to control the power generation capacity, and the repeated use of high-pressure gas and the accessory design of related devices can maintain a constant and continuous of power generation performance to achieve the effect of substantially supplying the “green energy”.

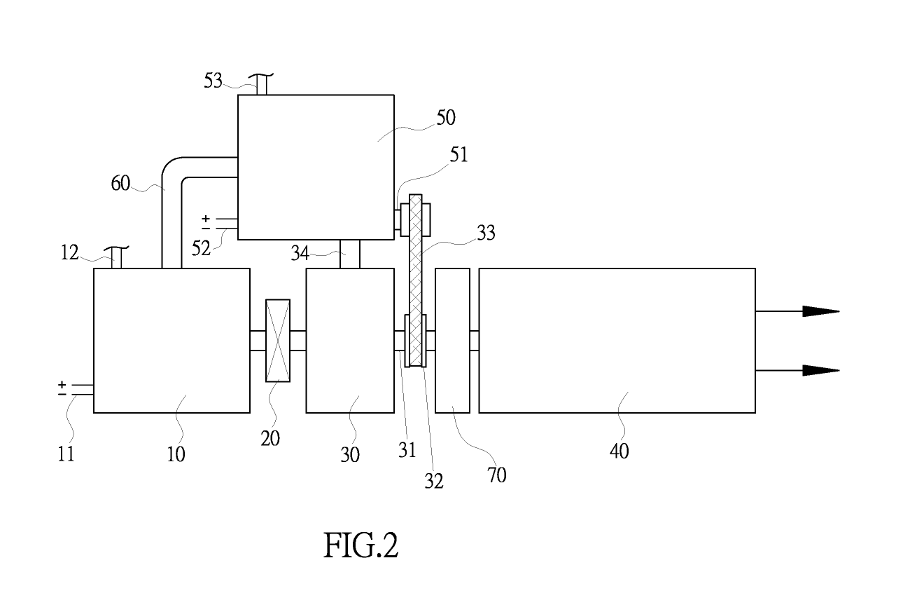

With reference to FIG. 2 for another preferred embodiment of the present invention, a gearbox 70 is provided for driving the high power generation motor 40 to enhance and assure the torque value during the operation of the transmission bearing 31. In the meantime, the rotating speed of the transmission bearing 31 can be adjusted according to actual requirements to control the power generation capacity effectively.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A pneumatic thrust combined cycle power generator, comprising a startup air compressor operated together with a high-pressure gas regulator to fill a high-pressure gas into a pneumatic motor and start operating a transmission bearing, such that the transmission bearing can drive a high power generation motor to produce a power generation effect and provide a power supply; and the transmission bearing of the pneumatic motor can be operated with a driven gear and a transmission belt to drive a high-pressure gas recycle air compressor to operate, so as to return the high-pressure gas to the startup air compressor through a high-pressure gas recycle channel and achieve a combined cycle effect of using the high-pressure gas.

2. The power generator of claim 1, wherein the startup air compressor includes an external power supply and an external air inlet.

3. The power generator of claim 1, further comprising a high-pressure gas recycle pipe installed between the pneumatic motor and the high-pressure gas recycle air compressor.

4. The power generator of claim 1, wherein the high-pressure gas recycle air compressor is operated by a rotating shaft driven by a transmission belt.

5. The power generator of claim 1, wherein the high-pressure gas recycle air compressor includes a spare external power supply and a spare external air inlet.

6. The power generator of claim 1, further comprising a battery module for storing additional generated power generated by the high power generation motor.

7. The power generator of claim 1, wherein the transmission bearing is coupled to a gearbox that is provided for driving the high power generation motor.
